(19) United States
(12) Patent Application Publication
(10) Pub. No.: US 2009/0254396 A1
(43) Pub. Date: Oct. 8, 2009

(54) Facility Energy Management System

(75) Inventor: Malcolm Stuart Metcalfe, West Vancouver (CA)

Correspondence Address: DAVIS WRIGHT TREMAINE, LLP/Seattle, 1201 Third Avenue, Suite 2200, SEATTLE, WA, 98101-3045, US

(73) Assignee: SEMPA POWER SYSTEMS LTD., North Vancouver, BC (CA)

(21) Appl. No.: 12/085,062

(22) PCT Filed: Nov. 14, 2006
(86) PCT No.: PCT/CA2006/001857

§ 371 Date: Nov. 20, 2008

(30) Foreign Application Priority Data
Nov. 14, 2005 (CA) 2527061
Nov. 14, 2005 (US) 11273718

(51) Int. Cl. G06Q 10/00; G06Q 50/00; G05D 23/19; G06F 1/28

(52) U.S. Cl. 705/8; 700/276; 700/295

(57) ABSTRACT

A method of managing energy supplied to a facility comprises monitoring a marginal cost of electricity from an electricity vendor; and determining a facility non-heating electrical load and a facility current heating load. The method also comprises obtaining fuel to supply energy to meet the heating load when the marginal cost of electricity is greater than a marginal cost of fuel or the non-heating electrical load is greater than a peak billed demand threshold. When the marginal cost of electricity is less than the marginal cost of the fuel and the non-heating electrical load is less than the peak billed demand threshold, electricity is obtained for the electricity vendor up to the peak billed demand threshold to supply energy to meet at least part of the current heating load, and fuel is obtained to supply energy to meet any current heating load not met by energy from the electricity.

### FIELD OF THE INVENTION

This invention relates generally to managing energy usage in a facility.

### BACKGROUND OF THE INVENTION

Energy for space heating, domestic hot water and recreation facilities such as swimming pools are some of the largest uses of energy in most facilities. Heating can be accomplished with electricity and/or any of a number of heating fuels. The most common heating fuels are petroleum based fuels such as heating oil, natural gas, or propane. Most facilities use a petroleum-based fuel for all their heating applications. Fuel costs can comprise a significant part of an energy bill for a facility located in colder climates wherein heating is required throughout the day and through multiple seasons of the year. Petroleum based fuel for heating is generally charged based on a commodity price plus a delivery charge, and does not change dramatically based on consumption during a billing period.

A facility's total electrical load comprises electricity used by devices and fixtures within the facility, including the facility electric heating load. The electrical load typically fluctuates throughout the day, with the lowest demand at night, and the highest demand in the late afternoon and early evening. Charges for electricity use are generally based on the amount of energy used over a billing period, plus a penalty for the maximum rate of use (billed kW demand charge). This structure penalizes a user for a high rate of use. Even though electricity demand through most of a day can be a small fraction of the peak electrical demand, the facility is charged a demand charge based on the peak usage.

Make up air systems draw air from outside and blow it into a facility to recirculate inside air and mix it with the fresh air from outside. The make up air systems may further comprise a gas fired heater for heating the outside air before delivery to the facility and may further comprise an air conditioning unit for cooling the air before delivery to the facility. Many of the make up air systems on facilities such as big box stores are a combination make up air system and furnace that recirculate inside air, and mix it with fresh air from outside. They also typically heat or cool the air as required.

A need exists to improve the management of energy usage in a facility.

### SUMMARY

Recent changes in petroleum fuel costs and electricity rate structures have created opportunities to reduce energy costs by selecting the most efficient means of providing the required heat to a facility. One aspect of the present invention therefore provides a system, memory or method to take advantage of the different pricing structures of fuel and electricity to provide energy to the facility in a cost efficient manner.

According to one aspect of the invention, there is provided a method of managing energy supplied to a facility that requires electricity and heat. According to another aspect of the invention, there is provided a computer readable memory having this method recorded thereon. The method comprises monitoring a marginal cost of electricity from an electricity vendor and determining a facility non-heating electrical load and a facility heating load. The method also comprises obtaining fuel to supply energy to meet the heating load when the marginal cost of electricity is greater than a marginal cost of a fuel or the non-heating electrical load is greater than a peak billed demand threshold. When the marginal cost of electricity is less than the marginal cost of the fuel and the non-heating electrical load is less than the peak billed demand threshold, electricity is obtained from the electricity vendor up to the peak billed demand threshold to supply energy to the meet at least part of the heating load, and fuel is obtained to supply energy to meet any heating load not met by energy from the electricity. By using electricity to meet at least part of the heat load when the non-heating electrical load is less than the peak billed demand threshold, the facility's electricity consumption fluctuations are smoothed and the amount of fuel consumed over a given period is reduced; in other words, the method serves to fill the valleys in the facility's fluctuating non-heating electrical load with electricity used to meet at least part of the heating load.

The method can further comprise monitoring energy prices of a power pool, and when the energy price of the power pool exceeds the collective cost of the electricity and the fuel, obtaining electricity from the electricity vendor and selling the obtained electricity to the power pool.

According to another aspect of the invention, a system can be provided that includes a processor programmed to carry out the above method, and sensors for determining a current heat load and a current electrical load of the facility. The processor is stored with or is communicative with electricity vendor electricity cost and fuel source fuel cost data. The system can include electric and fuel boilers communicative with the processor, and respectively operable to generate heat from the obtained electricity and fuel. The system can also include a control valve communicative with the processor and operable to control delivery of heat from the boilers to the facility. The system executes a reduced cost method of providing heat, from either electricity or fuel, or both. The system leverages the electricity rate structures to take advantage of low cost electricity that is available in off peak periods. The system reduces costs by displacing high cost fuel with low cost “off peak” electricity.

The peak billed demand threshold can be assigned a value equal to a historical peak billed demand threshold from a previous billing period. This is particularly useful when the electricity vendor charges a demand charge in each current billing period that is based on the peak billed demand over one or more previous billing periods. Should the current non-heating electrical load exceed the peak billed demand threshold, a new peak billed demand threshold value can be set that is equal to the current non-heating electrical load.

Alternatively, and to reduce the number of instances when the electricity vendor charges the facility a demand charge based on exceeding a demand charge threshold, the peak billed demand threshold can be assigned a value equal to the electricity vendor's demand charge threshold.

According to another aspect of the invention, there is provided method of managing energy supplied to a make up air system of a facility. According to another aspect of the invention, there is provided a computer readable memory having this method recorded thereon. The make up air system comprises a fuel powered heating unit for providing outside air or heated outside air to the facility, an air conditioning unit powered by an electric circuit for providing cooled outside air to the facility, and an electric heating coil powered by the electric circuit for providing heated outside air to the facility. The method comprises: monitoring a marginal cost of electricity from an electricity vendor; determining a facility non-heating electrical load and a facility heating load; when the marginal cost of electricity is greater than a marginal cost of fuel or the non-heating electrical load is greater than a peak billed demand threshold, using the heating unit to provide heated outside air to the facility; and when the marginal cost of electricity is less than the marginal cost of fuel and the non-heating electrical load is less than the peak billed demand threshold, using the electric heating coil to provide heated outside air to the facility to meet at least part of a heating load for heating the facility.

According to yet another aspect of the invention, there is provided a make up air system for a facility, comprising: a fuel powered heating unit for drawing in outside air and exhausting heated outside air into the facility; an air conditioning unit powered by an electrical circuit with electricity provided by an electricity vendor, the air conditioning unit for drawing in outside air and exhausting cooled outside air in the facility; an electric heating coil powered by the electrical circuit for exhausting heated outside air into the facility; electrical and heat load sensors for determining a non-heating electrical load and a heating load of the facility; and a processor communicative with the sensors and with the electricity vendor's electricity cost and a fuel source fuel cost. The processor is programmed to monitor a marginal cost of electricity from the electricity vendor; determine a facility non-heating electrical load and a facility heating load; use the heating unit to provide heated outside air to the facility when the marginal cost of electricity is greater than a marginal cost of fuel or the non-heating electrical load is greater than a peak billed demand threshold; and use the electric heating coil to provide heated outside air to the facility to meet at least part of a heating load for heating the facility when the marginal cost of electricity is less than the marginal cost of fuel and the non-heating electrical load is less than the peak billed demand threshold.

### DRAWINGS

The present invention will be further understood from the following detailed description, with reference to the accompanying drawings, in which:

FIG. 1 is a functional block diagram of an energy management system for a facility in accordance with one embodiment of the present invention;

FIG. 2 is a block diagram of inputs and outputs to a processor of the system;

FIG. 3 is a graph of a sample of daily electrical energy consumption by a typical facility within a given time period;

FIG. 4 is a flowchart of the system's generalized operation undertaken by the system processor;

FIG. 5 is a screen print of an information display from the system in operation at the facility;

FIG. 6 is a schematic diagram of a make up air system for a facility in accordance with one embodiment of the present invention; and

FIG. 7 is a flowchart of a make up air system's generalized operation undertaken by a system processor of an energy management system.

### DETAILED DESCRIPTION OF EMBODIMENTS OF THE INVENTION

### System Components

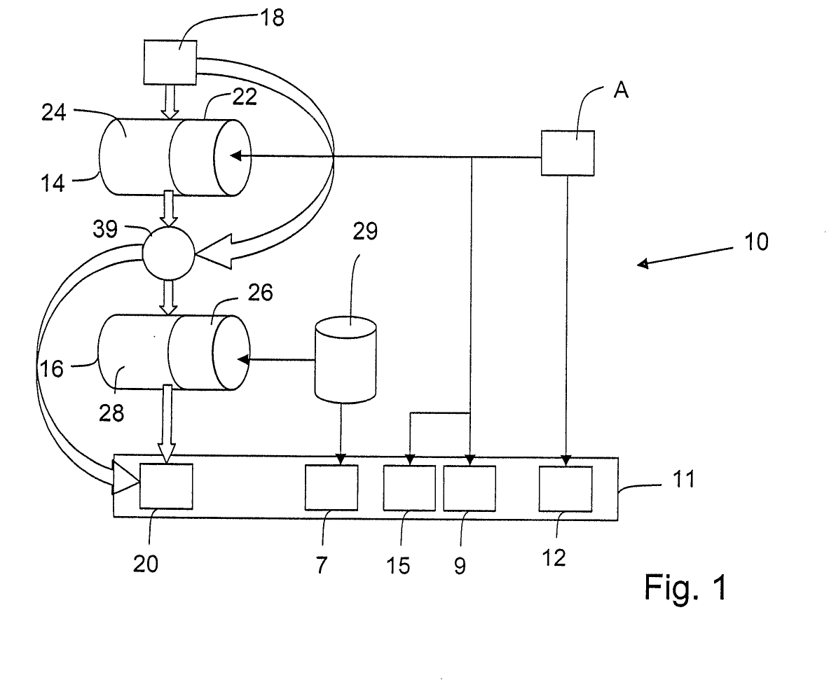

Referring to FIG. 1 and according to one embodiment of the invention, an energy management system 10 is provided that manages electricity and fuel used by a facility 11.

The facility 11 is a building that requires heat and electricity. The facility 11 uses electricity to power electrically-powered fixtures and devices found within the building. Collectively, these fixtures and devices impose an electrical load 12 on the facility 11 (“non-heating electrical load” 12). The facility 11 also uses electricity and fuel to power respective electric and fuel heating assemblies 14, 16. The electric and fuel heating assemblies 14, 16 heat one or more heatable fluids 18 for use in the facility 11. Such fluids include water, air, and other heatable fluids known in the art for storing and transferring heat, e.g. refrigerants. Heating the collective heatable fluid(s) impose a heat load 20 on the facility 11.

The electrical heating assembly 14 is comprised of an electrical heating element 22 and an electrical heat storage device 24. The heating element 22 can be one or more electric furnaces to heat air and/or one or more electric boilers to heat water. Instead or in addition to the electric furnace, the electric boiler can be coupled to a heat exchanger to heat air. The electrical heat storage device 24 can be a container for storing heated water, such as the boiler's water tank or a swimming pool. Similarly, the fuel heating assembly 16 is comprised of a fuel heating element 26 and a fuel heat storage device 28, wherein the fuel heating element 26 can be one or more fuel furnaces and/or fuel boilers, and the fuel heat storage device 28 can be a heated water storage container. One or more components of the electrical and fuel heating assemblies 14, 16 can pre-exist in the facility 11, in which case the energy management system 10 can use such components to manage electricity and fuel used by the facility 11.

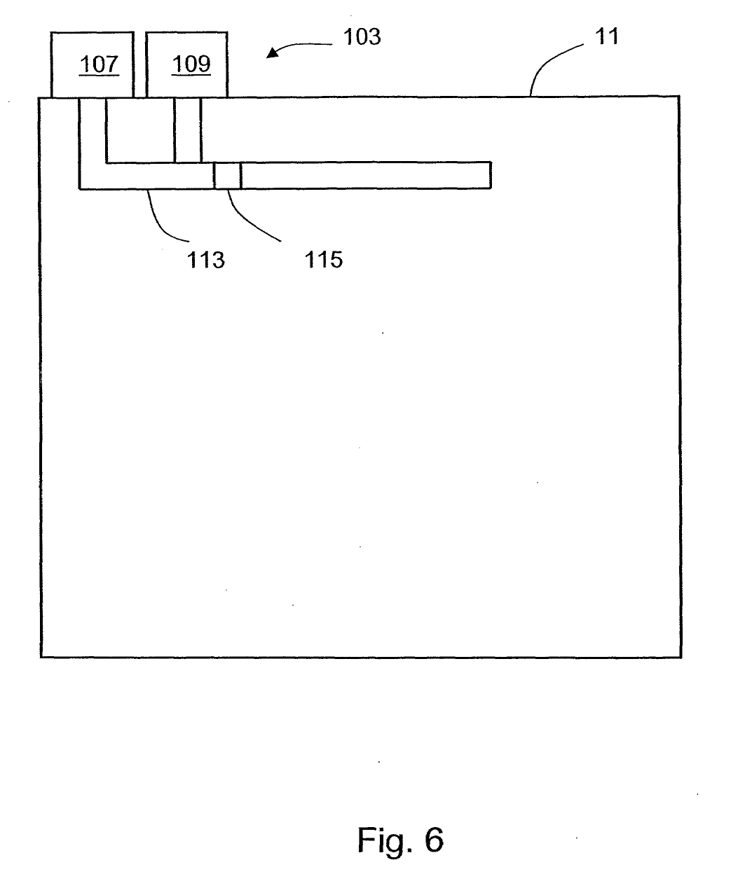

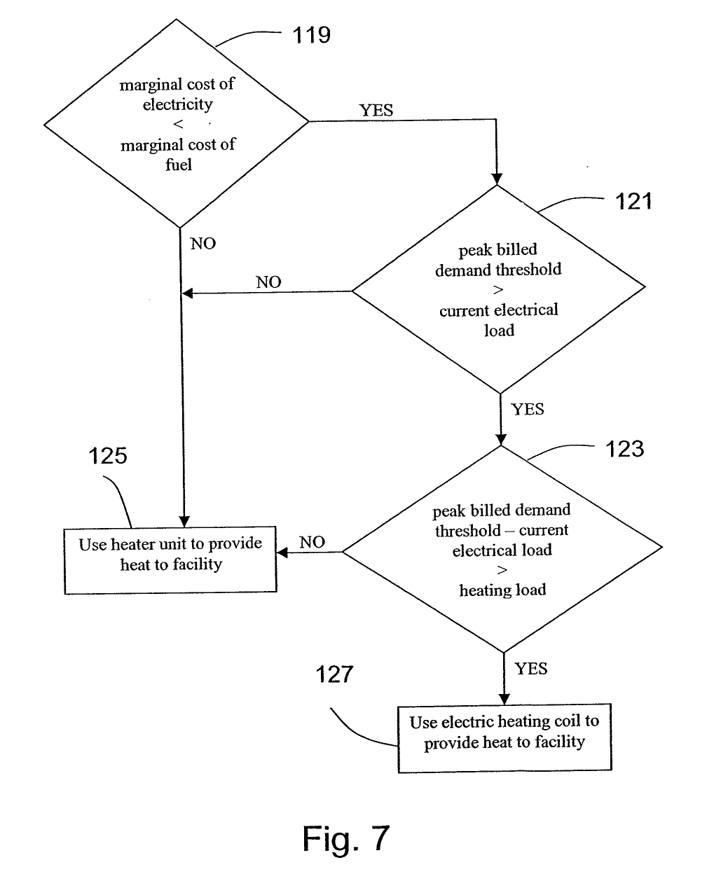

The facility 11 can also have a make up air system that includes an electrically powered air conditioning unit and a gas powered heating unit coupled to air ducting to provide heated and cooled air to the facility 11. When the facility has such a make up air system, the energy management system 10 can further comprise an electric heating coil 115 installed in the ducting as will be described in more detail below. If the facility 11 does not have a make up air system, a make up air system 103 can optionally be installed having a gas heater unit 107, an electric air conditioning unit 109, an electric heating coil 115, and ducting 113 for respectively cooling and heating the facility 11 (shown in FIGS. 6 and 7). The energy management system 10 controls the use of electricity and gas used by the make up air system 103 as will be described in detail below.

The facility 11 is electrically coupled to a conventional electrical power grid (not shown). Via the power grid, the facility 11 purchases electricity from an electricity vendor A, which can be an electric utility, an independent power producer (IPP), or a trader in a power pool. The purchased electricity is used to meet the non-heating electrical load 12 and power the electric heating assembly 14 (collectively, “facility total electrical demand”).

The facility 11 has a fuel storage tank 29 for storing fuel for use by the fuel heating assembly 16 and the optional heating unit 107. The fuel can be natural gas, butane, propane, heating oil or any other heating fuel as is known in the art. Fuel is purchased from a fuel vendor (not shown) who sends a tanker (not shown) to replenish the tank 14 from time to time. Alternatively, the facility 11 can be coupled to a fuel line (not shown) and the fuel vendor can supply fuel directly to the facility 11 via the fuel line.

Fuel is typically purchased from the fuel vendor at a fixed rate. Electricity, however, is typically purchased from the electricity vendor A at a rate that can vary depending on a number of factors. For example, when purchasing electricity from an electric utility such as British Columbia Hydro and Power Authority (“BC Hydro”), these factors include a demand for electricity (i.e. electrical load), supply voltage, and geographical area of the facility. BC Hydro customers who have an electricity demand at or over a certain number of kilowatts (kW) are billed on a rate schedule that includes a basic charge, a charge for electricity consumption, and a charge for demand. The basic charge is a fixed price for the billing period. The energy charge charges a fee per kilowatt hours (kWh) consumed over the billing period; this per kWh fee may change when electricity consumed exceeds a certain kWh threshold (“energy charge threshold”). The demand charge charges a fee per kW when the electrical load exceeds a certain kW threshold (“demand charge threshold”) within the billing period; the demand charge may contain multiple demand charge thresholds each with different per kW fees. Other electricity utilities may impose a demand charge in a different manner; for example, for some utilities, a demand charge is charged each billing period (e.g. per month) and is a percentage of the peak electricity demanded over a number of billing periods (e.g. over the last calendar year).

In addition to electric utilities, electricity can be purchased from other electricity vendors A, such as an IPP and traders in a power pool. Electricity can typically be purchased from an IPP at a fixed rate. In contrast, electricity purchased from the power pool is typically priced hourly, and the purchaser is billed at the rate that is in effect for each hour. Prices in a power pool can be extremely volatile and can fluctuate from hour to hour; the prices are typically lower at night when there is lower demand and a surplus of energy is available. Some utilities have adopted a similar billing structure, and charge customers based on time of day usage wherein the charge rate is different through the day; these utilities may or may not have an additional demand charge.

In practice, the demand charge makes up a significant portion of the total electric cost when the facility's total electrical demand exceeds the demand charge threshold at any time within the billing period, or if the customer's peak demand in one month is particularly higher than in other months. Electricity costs can be lowered by reducing the relative size of the demand charge to the energy charge. This can be achieved, for example, by reducing the peak billed demand threshold (peak shaving) and/or increasing electricity consumption during low demand periods (valley filling).

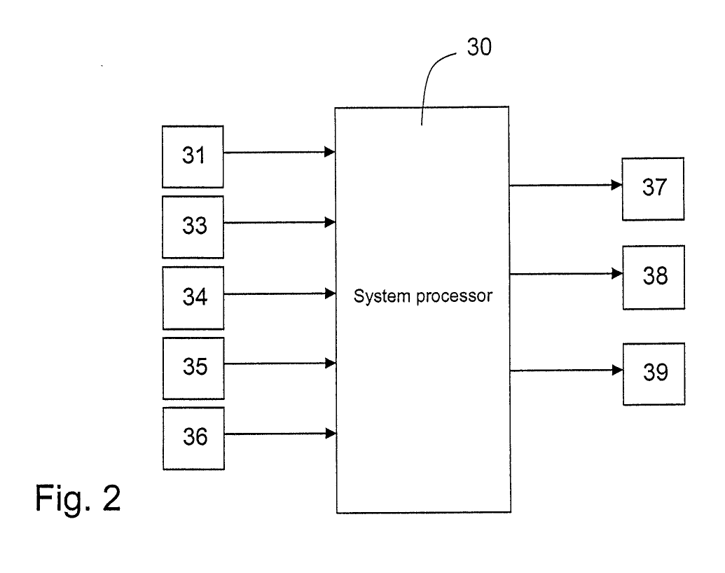

Referring now to FIG. 2, the system 10 includes a system processor 30 that is programmed to manage the use of electricity and fuel by the facility 11 to reduce the total energy costs to the facility 11. The system processor 30 can be a direct digital controller (DDC), a proportional integral derivative controller (PID), a programmable logic controller (PLC), an application specific integrated circuit (ASIC), a general purpose computer, or any type of programmable controller as is known in the art.

The processor 30 has a random access memory unit (not shown) that stores data relating to the price of electricity and the price of fuel. An input/output device such as an electronic display and keyboard (not shown) is coupled to the processor 30 and can be used to manually input new electricity and fuel pricing data into the processor 30. The processor 30 is also coupled to an external communications network 31 to automatically receive and store new electricity and pricing data; for example, a modem or network card (not shown) can be connected to the Internet to automatically update electricity and fuel pricing data from the electricity and fuel vendors. The electricity pricing data includes the current market rate of electricity available for purchase by the system 10, priced in units of kilowatthour (kWh). In addition, depending on the jurisdiction, the opportunity may exist to purchase or sell electricity through a power pool or purchase power contracts from an IPP. The electricity pricing data will also include information relating to, but not limited to, current power pool prices at the power pool, such as contracts entered into by the operating environment and current pool prices. Fuel pricing data includes the current market rate for the fuel available for purchase by the system 10. The market rate for the fuel will depend on the fuel being utilised. Fuels such as natural gas, propane and butane are typically priced in units of gigajoule (gJ).

The system 10 includes sensors communicative with the processor 30 that provide the processor 30 with data relating to the current energy load demanded by the facility 11 as well as the operational condition of the electric and fuel heating assemblies 14, 16 and the relevant components of the make up air system 103. The system 10 also includes actuators communicative with the processor 30 which are used to control operation of the electric and fuel heating assemblies 14, 16 as well as the distribution of heated fluids throughout the facility 11 and the operation of the make up air system 103. The sensors and actuators include:

Electrical heating system sensors 33: these sensors 33 are installed in the electrical heating assembly 14 and include temperature sensors for monitoring the temperature of the heatable fluids at the outlet of the electrical heating element 22 (to confirm the heating element 22 is operational) and in the heat storage device 24 (to measure the amount of energy available for heating), as well as meters for measuring the electrical power consumed by the electrical heating assembly 14 and the air conditioning unit 109 and the electric heating coil 115.

Fuel heating system sensors 34: these sensors 34 are installed in the fuel heating assembly 16 and include temperature sensors for monitoring the temperature of the heatable fluid(s) at the outlet of the fuel heating element 26 (to confirm the heating element 26 is operational), and in the heat storage device 28 (to measure the amount of energy available for heating) and may include meters for measuring the fuel consumed by the fuel heating assembly 16 and the heating unit 107.

Current electrical load sensors 35: these sensors 35 collectively measure the facility's total current electrical load, i.e. the instantaneous net electrical power demanded by all electrical facilities in the facility 11, including the power required by the electrical and fuel heating assemblies 14, 16 and the air conditioning unit 109 and the electric heating coil 115. Such sensors 35 may include voltage and current transformers connected to a wattmeter capable of calculating the power consumption and providing a signal to the processor 30. The current non-heating electrical load 12 can be determined by subtracting the total electrical load measured by sensors 35 from the electrical heating system electrical load measured by sensors 33.

Current heat load sensors 36: these sensors 36 collectively measure the temperature of the current heat load 20 at facility 11. Such sensors include temperature sensors for measuring the temperature of a hot water tank for supplying domestic hot water, rooms requiring space heating, heated swimming pools, hot tubs, etc, as well as air temperature sensors for measuring the air temperature of the facility 11.

Electrical heating assembly actuators 37: these actuators 37 control operation of the electric heating assembly 14 and include a switch that controls flow of electricity to the heating element 22, valves for controlling the flow of heated fluid to and from the heat storage device 24, flow of electricity to the air conditioning unit 109 and the electric heating coil 115.

Fuel heating assembly actuators 38: these actuators 38 control operation of the fuel heating assembly 16 and include a valve that controls fuel flow to the heating element 26 and the heating unit 107, spark ignitor for igniting the fuel, and may include valves for controlling the flow of heated fluid to and from the heat storage device 28.

Main fluid control valve(s) 39: a main fluid control valve 39 is provided for each heatable fluid to control the flow of the heatable fluid from the electrical and fuel heating assemblies 14, 16 to the rest of the facility 11. As shown in FIG. 1, the main control valve 39 is fluidly coupled to a conduit that receives unheated fluid 18 directly from a fluid source, a conduit that receives heated fluid from the electric heating assembly 14, a conduit that feeds fluid 18 directly to the heat loads 20 within the facility 11, and a conduit that feeds fluid through the fuel heating assembly 16 and to the heat loads 20.

### Processor Programming and System Operation

The processor 30 is programmed to monitor the electricity and fuel pricing and current electrical and heat loads 12, 20, and to execute a strategy for using electricity and fuel in a manner that reduces the total energy costs to the facility 11.

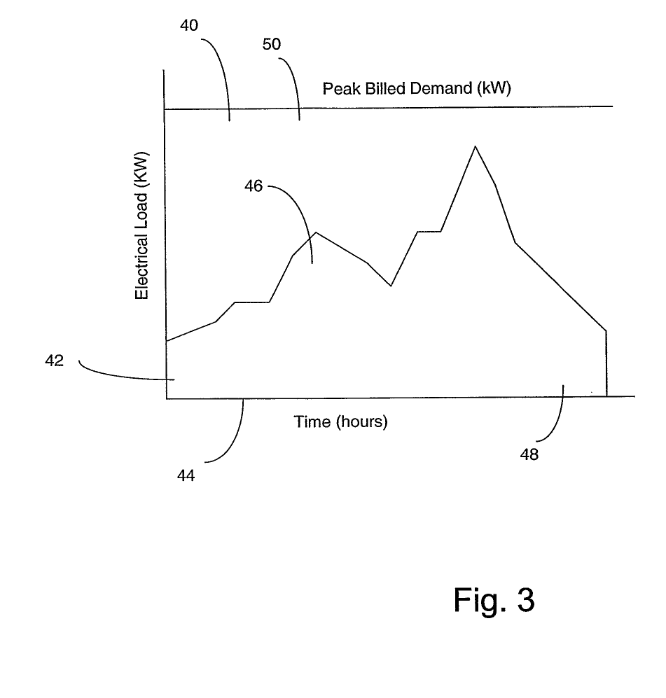

Referring to FIG. 3 the processor 30 is programmed with a “valley filling” strategy that makes use of electrical power in non-peak periods. This strategy operates under the constraint that the current non-heating electrical load 12 of the facility 11 will never exceed a specified peak billed demand threshold 40. The peak billed demand threshold 40 is a maximum allowable net electrical power, as measured for the peak demand measurement, demanded by all electrical devices in the facility 11 other than the electrical heating assembly 14 that is expected in the current demand billing period. Typically this value is assigned to be the peak billed demand recorded and billed during the same month in previous year or years; however, the value may be based on any historical period of time and dynamically updated to account for unexpected electrical power consumption conditions. The vertical axis 42 in FIG. 3 represents electrical load in kW, while the horizontal axis 44 represents the time of day in hours, beginning at midnight and ending 24 hours later at midnight. The function 46 illustrates the non-heating electrical load 12 of the facility 11 over a typical day (i.e. the electrical load of all devices and fixtures not including the electrical and fuel heating assemblies 14, 16). The area 48 below the function 46 is the total electrical energy in kWh consumed by the facility 11 over a typical day in kWh excluding the electricity consumed by the electrical and fuel heating assemblies 14, 16 and the air conditioning unit 109. The area 50 above the function 46 and constrained by the peak billed demand threshold 40 line is the electrical energy in kWh available for valley filling.

When the facility 11 purchases electricity from an electricity vendor A that charges an additional demand charge that is triggered when the current non-heating electrical load 12 exceeds the current billed demand charge threshold, the processor 30 can assign the peak billed demand threshold 40 to be a value that is less than or equal to the demand threshold. In such case, the area 50 represents the electrical energy in kWh available for use by the facility that will not be subject to a demand charge.

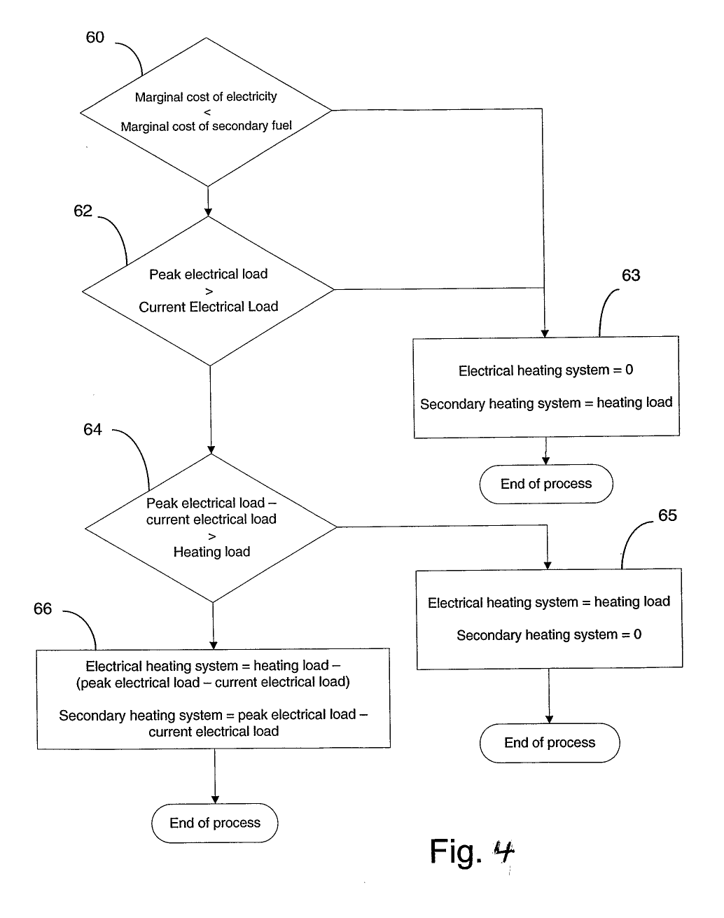

Referring now to FIG. 4 the processor 30 program executes the valley filing strategy by continuously iterating through the following process steps:

At a first stage shown as block 60, the processor 30 compares the marginal cost of the fuel to the marginal cost of electricity by accessing this information stored in the memory unit, or externally via the communications network 31. The marginal cost of the fuel is calculated by taking the price of fuel, converting it to units of $/gJ, and accounting for the efficiency of the fuel heating assembly 16 and/or the heating unit 107. Similarly, the marginal cost of electricity is calculated by taking the price of electricity, converting it to units of $/gJ, and accounting for the efficiency of the electrical heating assembly 14 and/or the air conditioning unit 9 and/or the heating coil 115.

When the marginal cost of electricity is greater than the marginal cost of the fuel, the processor 30 is programmed to advance to stage 63 wherein the electrical heating assembly 14 and/or the electric heating coil 115 are turned off and the fuel heating assembly 16 and/or the heating unit 107 are set to generate sufficient heat energy to satisfy the heating load 20. Operation of the electric and fuel heating elements 22, 26 such as electric and fuel boilers and electric and gas furnaces and the electric heating coil 115, air conditioning unit 109 and heating unit 107 are well known in the art and thus not described in detail. In addition, the main fluid control valve 39 is set to deliver unheated heating fluid to the fuel heating assembly 16 for heating.

When the marginal cost of electricity is less than the marginal cost of fuel then the processor 30 is programmed to advance to block 62 wherein the peak billed demand threshold 40 is compared to the current non-heating electrical load 12 as measured by the current electric load sensors 33. When the peak billed demand threshold 40 is less than the current non-heating electrical load 12, the processor 30 is programmed to advance to block 63. At this stage, the electrical heating assembly 14 and/or the electric heating element 115 are turned off and the fuel heating assembly 16 and/or the heating unit 107 are set to generate sufficient heat energy to satisfy the heating load 20. In addition, the main fluid control valve 39 is set to deliver unheated heating fluid to the fuel heating assembly 16 for heating.

When the peak billed demand threshold 40 is greater than the current non-heating electrical load 12 then the processor 30 is programmed to advance to block 64 wherein the difference between the peak billed demand threshold 40 and the current non-heating electrical load 12 is compared to the heating load 20 as measured by the current heat load sensors 36. When the heating load 20 can be satisfied by the electrical heating assembly 14 without increasing the total electrical demand beyond the peak billed demand threshold 40 then the processor 30 is programmed to advance to block 65 wherein the electrical heating assembly 14 and/or the electric heating coil 115 generates sufficient heat energy to satisfy the heating load 20 and the fuel heating assembly 16 and/or the heating unit 107 are turned off. In addition, the main fluid control valve 39 is set to deliver the heated fluid from the electrical heating assembly 14 directly to the heating load 20.

When the heating load 20 cannot be satisfied by the electrical heating assembly 14 without increasing the total electrical demand beyond the peak billed demand threshold 40 then the processor 30 is programmed to advance to block 66 wherein at least one of the electrical heating assembly 14 or the heating coil 115 is set to generate sufficient heat energy to raise the total electrical demand to the peak billed demand threshold 40, without exceeding the peak billed demand threshold 40. The main fluid control valve 39 is also set to deliver the heated fluid from the electrical heating assembly 14 to the fuel heating assembly 16. The fuel heating assembly 16 and the heating unit 107 are set to generate the remaining heat energy required to satisfy the heating load 20.

According to a second embodiment of the invention, the processor 30 is further programmed with a second energy management strategy that monitors the price difference between the electricity vendor A and the power pool, and sells electricity purchased from the electricity vendor A under cost-advantageous circumstances. Depending on the jurisdiction, an opportunity may exist to purchase or sell electricity through a power pool or purchase power contracts from an IPP. Power purchased from an IPP is generally carried out under a fixed price contract. In contrast, power purchased from the power pool is typically priced hourly and the purchaser is billed at the rate that is in effect for each hour. Power pool prices may be extremely volatile and fluctuate significantly from hour to hour. For example, the price may be very low at night when there is surplus energy available, but in the event of a significant problem with one or more sources of supply, the night price can spike to 10 to 15 times the normal price. This generally lasts for 1 to 2 hours before the price falls back to normal levels.

When the facility 11 contracts with an IPP for the purchase of a fixed amount of power, the facility 11 cannot typically control exactly how much power it consumes. A customer with an IPP contract that uses either more or less power than the contracted amount is deemed to have purchased or sold the difference from the power pool at the price that is in effect during the hour of interest. The system 10 takes advantage of these factors by selling power to the power pool when the power pool price spikes significantly and relying solely on the fuel heating assembly 16 and the heating unit 107 to satisfy the heating load 20. In particular, the processor 30 is programmed to monitor the prices of the power pool via an external communications network (not shown). When the difference between the marginal cost of the fuel and the power pool price is greater than the marginal cost of electricity, it is more cost effective to sell electricity to the power pool, and the processor 30 stops operation of the electrical heating system 14, and the electric heating coil 115 and activates the fuel heating system 16 and the heating unit 107, and then purchases electricity from the IPP up to the maximum contracted amount and sells this electricity to the power pool.

The processor 30 is programmed to ensure that the facility has sufficient energy to meet its energy demands, sufficient purchased electricity is reserved to meet the current non-heating electrical load 12. Backup generators (not shown) can be provided in the system 10 to alleviate energy shortages caused by unexpected current electrical load spikes.

### Make UP Air System

Referring to FIG. 6 and according to another embodiment of the invention, a make up air system is shown generally at 103 for use with the facility 11. Most make up air systems are on the roof areas of facilities and exhaust the outside air into the facility 11 via a duct system or the like. The facility energy management system 10 control the use of electricity and gas by the make up air system 103, by using the electric heating coil 115 to provide heat to the facility 11 when the marginal cost of electricity is less than the marginal cost of fuel and the peak billed demand threshold is greater than the current non-heating electrical load of the facility 11.

The make up air system 103 includes the heating unit 107 which draws outside air and optionally heats it before exhausting the outside air into the facility 11, via, for example the duct system 113 installed into the facility 11. The heating unit 107 may be a gas fired heater and includes a fan or the like for exhausting the outside air into the facility 11. The heating unit 107 generally obtains fuel from a fuel vendor (not shown). Also included in the make up air system 103 is the air conditioning unit 109 for cooling outside air and exhausting it into the facility 11, via, for example the duct system 113 of the facility 11. The air conditioning unit 109 may be any suitable air conditioning unit of a suitable size for drawing in outside air, cooling it and exhausting it into the facility 11. The air conditioning unit 109 is generally powered by electricity supplied by an electricity vendor (not shown) and results in the need for a large electrical circuit (not shown).

As the air conditioning unit 109 requires a large electrical circuit, the electrical circuit may advantageously be used to provide electricity for heating the facility 11 as well. An electric heating coil 115 may be powered by the electrical circuit for heating at least some outside air which is then exhausted into the facility 11, via, for example the duct system 113. The electric heating coil 115 may be mounted directly in the duct system 113 and may optionally include a fan for exhausting the heated air into the facility 105 or may alternatively use the fan of the heating unit 107 to exhaust air heated by the electric heating coil 115 into the facility 105.

An interlock (not shown) may be installed to disconnect or disrupt electrical power from the air conditioning unit 109 when heating is required to ensure that the heating and cooling are not used at the same time. For example, a physical interlock that would disconnect the electrical supply from the air conditioning unit 109 when needed for heating, and return the connection, disconnecting the electrical supply from the electric heating coil 115, when cooling is needed may be used. Suitable such physical interlocks are known in the art and thus not described in detail here.

As discussed above with reference to FIGS. 1-5, the electric heating coil 115 may be used to provide heat to the facility at times when the marginal cost of electricity is below that of the marginal cost of fuel, for example at off peak times.

When heating of the facility 11 is required, a combination of both the fuel powered heating unit 107 and the electric heating coil 115 may be used, or alternatively either the heating unit 107 or the electric heating coil 115 may be used individually, depending on whichever results in the most cost effective heating of the facility 11. This is determined by a system processor 30 as described with reference to FIGS. 2 and 3 above. The processor is communicatively connected to the make up air system to control operation of the heating unit 107 and heating coil 115.

The air make up system 103 of the present embodiment is used in conjunction with an energy management system, for example the system 10 as described above with reference to FIGS. 1-5, which is capable of determining and comparing the marginal cost of electricity and the marginal cost of fuel and determining a cost efficient manner of providing heat to the facility 11 based on a number of factors as discussed above.

Facilities can have conventional make up air systems already installed therein. Such conventional make up air systems typically comprise air conditioning units which use gas for heating via the heating unit and electricity for cooling via the air conditioning unit. This embodiment is particularly useful as a retrofit to facilities having such make up air systems. When performing such retrofit, the heating coil 115 is installed in the existing air duct of the facility, and the heating unit and air heating coil are communicatively connected to the processor 30.

Referring to FIG. 7, and according to an embodiment of the invention, the operation of an air make up system having a fuel powered heating unit, an electricity powered air conditioning unit and an electric heating coil is provided. Operation of the air make up system is controlled by the energy management system 10 having a system processor 30 with a memory encoded with the following steps and instructions in which the processor 30 executes as described below:

In step 119, the marginal cost of electricity is compared to the marginal cost of fuel. These marginal costs can be pre-programmed based on historical values, given values from vendors or by accessing the values via an external communications network as outlined below with reference to FIG. 2. If the marginal cost of electricity is less than the marginal cost of fuel then the method proceeds to step 121 where the peak billed demand threshold is compared to the current non-heating electrical load to determine if electrical energy is available for providing electrical power for heating without exceeding the peak billed demand threshold. If the peak billed demand threshold is greater than the current non-heating electrical load the method proceeds to step 123 where it is determined whether the difference between the peak billed demand threshold and the current non-heating electrical load is sufficient to provide enough energy to the heating coil 115 to fulfill the demand of the heating load. If the difference is larger than the heating load demand, the method proceeds to step 127 where processor 30 activates the electric heating coil 115 to provide heat to the facility 11.

The method proceeds to step 125 if it is determined in step 119 that the marginal cost of fuel is lower than the marginal cost of electricity, if in step 121 the current non-heating electrical load is greater than the peak billed demand threshold, or if in step 123 the difference between the peak billed demand threshold and the current non-heating electrical load is insufficient to meet the demand of the heating load. At step 125, the processor 30 activates the gas heater unit 107 to provide heat to the facility 11.

Optionally, the processor 30 can be programmed to heat the facility 11 with a combination of heat supplied by the heating unit 107 and by the heating coil 115. Such combined heating is carried out when the processor determines that the difference between the peak billed demand threshold and the current non-heating electrical load is insufficient to meet the demand required by the heating load. In such case, the processor 30 activates the heating coil 115 to provide an amount of heat to the facility less than or equal to the difference between the peak billed demand threshold and the current non-heating electrical load. The processor 30 then determines the remaining energy required to meet the heating load demand, then activates the heater unit 107 to provide the remaining required heat.

### EXAMPLE

The system 10 can be installed at a facility having a gas heating system used to provide heat for an outdoor swimming pool, two outdoor spa pools, a snow melting system and some building space heating. The pool and spa facilities operate on a year round basis. The resort heating system initially consists of two 2.9 M BTUH boilers, operating at approximately 70% efficiency. Either boiler is capable of providing all required heat to meet the facility heat load. The output from the two boilers is directed to the individual heating loads using an electrically controlled mixing valve and a heat exchanger for each load.

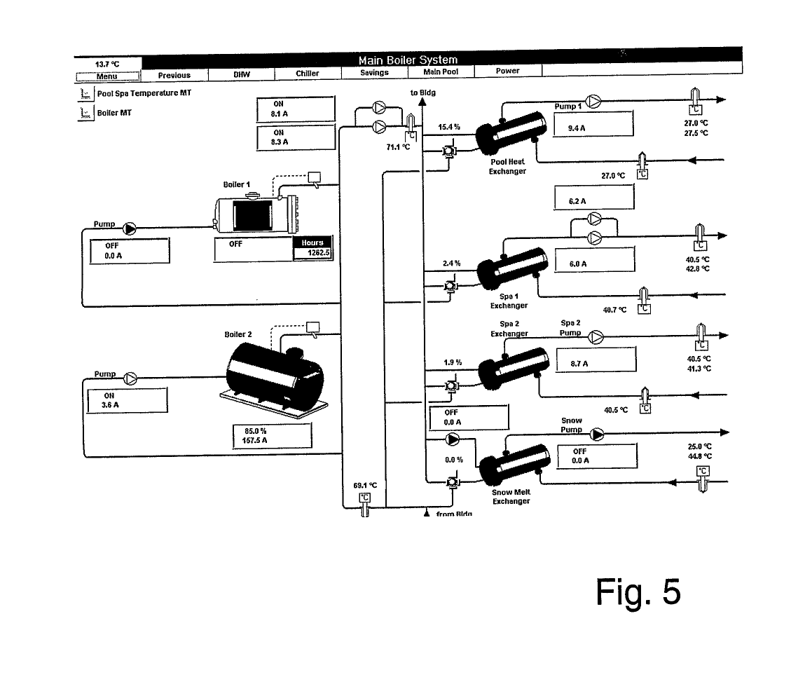

Installing the system 10 involves replacing one of the two boilers with a 300 kW Caloritech electric boiler. A Delta Controls Direct Digital Control (DDC) system can be installed to control both the existing and the new boiler, as well as the mixing valves used to manage the heat directed to each of the heating loads. FIG. 5 shows a schematic of a completed installation.

The control system monitors temperatures on each of the heating loops and controls both the boilers and the mixing valves. Selection of the electric or propane boilers as a heat source is completed automatically by the DDC control as programmed in the above description.

After the system is installed and operating, propane costs are expected to be reduced for the entire facility by approximately 50%, while electricity costs increased by less than 20%. Monthly net savings of up to $6,000 are expected.

While illustrative embodiments of the invention has been described, it will be appreciated that various changes can be made therein without departing from the scope and spirit of the invention.

1.-24. (canceled)

25. A method of managing energy supplied to a make up air system of a facility, the make up air system comprising a fuel powered heating unit for providing outside air or heated outside air to the facility, an air conditioning unit powered by an electric circuit for providing cooled outside air to the facility, and an electric heating coil powered by the electric circuit for providing heated outside air to the facility, the method comprising:
a) monitoring a marginal cost of electricity from an electricity vendor;
b) determining a facility current non-heating electrical load and a facility current heating load;
c) when the marginal cost of electricity is greater than a marginal cost of fuel or the current non-heating electrical load is greater than a peak billed demand threshold, using the heating unit to provide heated outside air to the facility; and
d) when the marginal cost of electricity is less than the marginal cost of fuel and the current non-heating electrical load is less than the peak billed demand threshold, using the electric heating coil to provide heated outside air to the facility to meet at least part of a heating load for heating the facility.

26. The method of claim 25, further comprising in (d) when the difference between the peak billed demand threshold and the current non-heating electrical load is greater than a heating load required to heat the facility, using the electric heating coil to provide heated outside air to the facility to meet all of the heating load for heating the facility.

27. The method of claim 25, further comprising:
applying an interlock for disconnecting the electrical supply to the air conditioning unit when operation of the electric heating coil is required and disconnecting the electrical supply to the electric heating coil when operation of the air conditioning unit is required.

28. The method of claim 25, further comprising in (c) obtaining electricity from the electricity vendor to meet at least part of the current non-heating electrical load.

29. The method of claim 25, wherein the fuel is selected from a group consisting of heating oil, propane, natural gas, and butane.

30. The method of claim 25, further comprising monitoring energy prices of a power pool, and when the energy price of the power pool exceeds the collective cost of the electricity and the fuel, obtaining electricity from the electricity vendor and selling the obtained electricity to the power pool.

31. The method of claim 25, wherein the peak billed demand threshold is assigned a value equal to a demand charge threshold set by the electricity vendor.

32. The method of claim 25, wherein the peak billed demand threshold is assigned a value equal to a historical peak billed demand threshold from a previous billing period.

33. The method of claim 25, further comprising in (c) when the current non-heating electrical load is greater than the peak billed demand threshold: assigning the peak billed demand threshold a new value equal to the current electrical load.

34. A method as claimed in claim 25 wherein the step of monitoring comprises accessing data relating to the marginal cost of electricity stored on a memory or via a communications network.

35. A make up air system for a facility, the make up air system comprising:
a fuel powered heating unit for drawing in outside air and exhausting heated outside air into the facility;
an air conditioning unit powered by an electrical circuit with electricity provided by an electricity vendor, the air conditioning unit for drawing in outside air and exhausting cooled outside air in the facility;
an electric heating coil powered by the electrical circuit for exhausting heated outside air into the facility;
electrical and heat load sensors for determining a current non-heating electrical load and a current heating load of the facility;
a processor communicative with the sensors and comprising a memory having recorded thereon statements and instructions for execution by the processor to
a) monitor a marginal cost of electricity from the electricity vendor;
b) determine a facility current non-heating electrical load and a facility current heating load;
c) use the heating unit to provide heated outside air to the facility when the marginal cost of electricity is greater than a marginal cost of fuel or the current non-heating electrical load is greater than a peak billed demand threshold; and
d) use the electric heating coil to provide heated outside air to the facility to meet at least part of a heating load for heating the facility when the marginal cost of electricity is less than the marginal cost of fuel and the current non-heating electrical load is less than the peak billed demand threshold.

36. The system of claim 35, further comprising:
a duct system for distributing the exhausted outside air into the facility from the heating unit, the air conditioning unit and the electric heating coil.

37. The system of claim 36, wherein the electric heating coil is mounted in the duct system.

38. The system of claim 35, further comprising:
an interlock for disconnecting the electrical supply from the air conditioning unit when the operation of the electric heating coil is required and for disconnecting electrical supply from the electric heating coil when operation of the air conditioned unit is required.

39. The system of claim 35, wherein the processor is programmed in (d) to use the electric heating coil to meet all of the heating load when the difference between the peak billed demand threshold and the current non-heating electrical load is greater than a heating load required to heat the facility.

40. The system of claim 35, wherein the heating unit is adapted for use with fuel is selected from a group consisting of heating oil, propane, natural gas, and butane.

41. The system of claim 35, wherein the peak billed demand threshold is assigned a value equal to a demand charge threshold set by the electricity vendor.

42. The system of claim 35, wherein the peak billed demand threshold is assigned a value equal to a historical peak billed demand threshold from a previous billing period.

43. The system of claim 35, wherein the peak billed demand threshold is assigned a new value equal to the current electrical non-heating load when the current electrical load is greater than a peak billed demand threshold.

44. The system of claim 35, wherein the statements and instructions recorded on the memory for execution by the processor to monitor the marginal cost of electricity from the electricity vendor comprise statements and instructions for execution by the processor to access data relating to the marginal cost of electricity stored on a memory or via a communications network.
